(19) United States
(12) Patent Application Publication
(10) Pub. No.: US 2021/0336796 A1
(43) Pub. Date: Oct. 28, 2021

(54) SYSTEM AND COMPUTER METHOD INCLUDING A BLOCKCHAIN-MEDIATED AGREEMENT ENGINE

(71) Applicant: CHRISTOPHER A. WIKLOF, EVERETT, WA (US)

(72) Inventor: CHRISTOPHER A. WIKLOF, EVERETT, WA (US)

(21) Appl. No.: 17/011,857

(22) Filed: Sep. 3, 2020

Related U.S. Application Data
(60) Provisional application No. 62/895,384, filed on Sep. 3, 2019.
(60) Provisional application No. 63/022,300, filed on May 8, 2020.

(51) Int. Cl. H04L 9/32; H04L 9/08

(52) U.S. Cl. CPC H04L 9/3247; H04L 9/0894; H04L 9/3228; H04L 9/3242

(57) ABSTRACT

Computer methods and systems provide a way to obtain an agreement from a proposed recipient (e.g., a counterparty) of a blockchain-mediated payload data file governing conditions of providing access to the payload data file before providing the payload data file to the proposed recipient.

### CROSS-REFERENCE TO RELATED APPLICATIONS

The present application claims priority benefit from co-pending U.S. Provisional Patent Application No. 62/895,384, entitled “SYSTEM AND METHOD INCLUDING AN AGREEMENT ENGINE WITH BLOCKCHAIN ACCESS,” filed on Sep. 3, 2019 (docket number 2581-018-02). The present application also claims priority benefit from co-pending U.S. Provisional Patent Application No. 63/022,300, entitled “SYSTEM AND METHOD FOR IMMUTABLE DATA STORAGE AND RETRIEVAL,” filed May 8, 2020 (docket number 3034-001-02). Each of the foregoing applications, to the extent not inconsistent with the disclosure herein, is incorporated by reference.

### SUMMARY

Every great company starts with a great team organized around an idea. For a great team to organize, there must be an agreement between team members. Most typically, early teams are formed from individuals who know one another and, at least provisionally, trust one another. The agreement that binds such teams is typically socially-based and may, at least at first, be implied rather than overtly stated.

For example, if Sam's colleague Sara approaches Sam with a new idea for an enterprise, Sam understands that he should not share Sara's idea with Sean, at least not without Sara's agreement to sharing with Sean. Sara's agreement to sharing with Sean, especially if she does not know Sean, is typically based on Sara trusting Sam's judgment and Sam's endorsement of Sean. Generally, Sam's recommendation and endorsement of Sean is a function of Sam's knowledge of Sean's expertise and trustworthiness.

The penalty for Sam or Sean violating Sara's trust is social. Sara will recognize that Sam and/or Sean violated her trust and will recognize the risk of trusting Sam's honesty or judgment. Sara might never again share a secret with Sam and/or with Sean. Sara might tell other colleagues about Sam or Sean's violation of trust. Sam and/or Sean, especially if the violation of trust forms a pattern, may be socially and/or professionally shunned.

Having a good reputation is critical to innovators, entrepreneurs, subject matter experts, service providers, and/or capital sources with respect to exposure to deals. The span of a good social reputation is limited. Typically, for sensitive early stage ideas, trust spans only one to three degrees of separation between parties, unless the trust is guaranteed by a third party professional or licensing organization (such as a bar association or the like).

When the degree of separation between would-be trusted collaborators is greater, sharing events (which may be referred to herein as a type of transaction) slow. The slowing of transactions associated with new ideas adds friction to development and reduces efficiency that is often critical to idea development, team recruitment, company organization and capital formation.

What is needed is a system and computer method for establishing agreements between early stage collaborators that provides social enforcement for the established agreements. Such a system and computer method may provide for rapidity of transactions by improving certainty and security of communications. In an embodiment, such a system and computer method provides a pathway for agreements of increasing complexity and enforceability, through and including legal agreements having associated legal remedies.

According to an embodiment, a computer method for sharing sensitive electronic information includes receiving, into a server computer, from a first party via a first graphical user interface (GUI) of a device having a first communication coordinate in network communication with the server computer, a selection of an agreement parameter corresponding to a proposed agreement required for transfer of designated payload data. The computer method includes receiving, into the server computer, from the first party via the first GUI of the device having the first communication coordinate in network communication with the server computer, a designation of a second communication coordinate corresponding to a second party, the second party being the intended recipient of designated payload data. The computer method includes establishing the designated payload data from the first party, the designated payload data being intended for delivery to the second party only after receiving of the proposed agreement by the second party and receiving an approval of the proposed agreement by the second party. The computer method includes establishing, in the server computer, a first private encryption key assigned to the first party, encrypting, with the server computer, the designated payload data using the first private encryption key and at least temporarily storing the encrypted payload data in a first protected memory, and generating, in the server computer, an electronic message for transmission to the second party, the electronic message including a first link and a request to activate the first link. The computer method includes transmitting the electronic message to the second party at the second communication coordinate, receiving actuation of the first link, and outputting the proposed agreement and an object for receiving acknowledgement or approval by the second party for display to the second party via a GUI displayed on a second party electronic device. The computer method includes receiving approval of the proposed agreement from the second party, transmitting a second link to the second party, the second link corresponding to an expression of the designated payload data by the second party electronic device, recording, with the server computer in a second protected memory accessible by at least the first party, the acceptance or approval of the agreement as a binding agreement, and recording, in the second protected memory, actuation of the second link and inferred expression of the designated payload data by the second party electronic device.

According to an embodiment, a computer method for blockchain mediation of an agreement between a party and a counterparty includes receiving, via a first party graphical user interface from a first party into a server computer, a designation of a first payload data file for sharing with a counterparty subject to an agreement, and identifying, with a server computer, a proposed agreement governing a relationship between a party and a counterparty with respect to the first payload data. The computer method includes presenting the proposed agreement to the counterparty via a counterparty graphical user interface, and receiving, into the server computer, a notice of acceptance of the proposed agreement by the counterparty. The computer method includes labeling, in a metadata object, the first payload data as accessible to the counterparty according to terms of the accepted agreement, and updating the counterparty graphical user interface to indicate access to the first payload data.

### BRIEF DESCRIPTION OF THE DRAWINGS

FIG. 1 is a flowchart illustrating a computer method for sharing sensitive electronic information, according to an embodiment.

FIG. 2 is a system diagram showing principal portions of a system for presenting immutable payload data to the user and for storing data, according to embodiments.

FIG. 3 is a flowchart illustrating a computer method for blockchain mediation of an agreement between a party and a counterparty, according to an embodiment.

FIG. 4 is a depiction of a graphical user interface for receiving a command, into a server computer, for establishing a new payload data file, according to an embodiment.

FIG. 5 is a depiction of a graphical user interface for adding a new document as a payload data object, according to an embodiment.

FIG. 6 is a depiction of a graphical user interface for receiving a designation that the first payload data file is intended to be shared with a counterparty, according to an embodiment.

FIG. 7 is a depiction of a graphical user interface for selecting a sharing agreement to govern terms under which the payload data is shared with the counterparty, according to an embodiment.

FIG. 8 is a depiction of a graphical user interface for presenting a proposed agreement to the counterparty, according to an embodiment.

FIG. 9 is a depiction of a graphical user interface for indicating access to shared first payload data, according to an embodiment.

FIG. 10 is a depiction of a default sharing agreement comprising a standard user agreement for acceptance by the counterparty, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

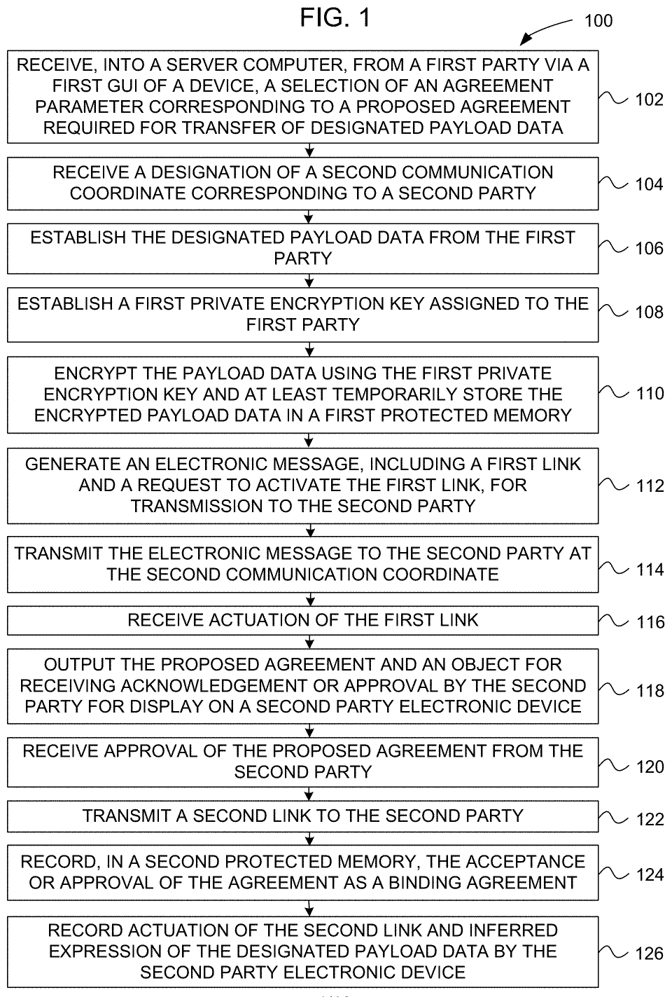

FIG. 1 is a flowchart illustrating a computer method 100 for sharing sensitive electronic information, according to an embodiment.

According to embodiments, computer methods and systems provide a way to obtain an agreement from a proposed recipient of information before providing the information to the proposed recipient. According to an embodiment, a proposed agreement is selected via a first user graphical user interface (GUI). In an embodiment, the proposed agreement is not a legal agreement, but rather is a social agreement wherein remedies are substantially limited to social media endorsement or disapprobation of subsequent recipient actions. Acceptance, via a second user GUI, of the proposed agreement is a requirement for a second (intended recipient) user to be allowed to witness a transducer output of payload data. The payload can be a conventional character/byte/hex, . . . message, for example. According to an embodiment, the payload is a linked-to, unique, permanent output driver file or stream, the output driver being operatively coupled to drive a transducer, the transducer including one or more of an electronic display, an electronic immersive environment, a loudspeaker, a haptic device, or an audio system including at least a left channel and at least a right channel loudspeaker.

In an embodiment, a displayable GUI lists one or more of a payload objects display pane. A selected payload object, e.g., a thumbnail showing function or object/subject, references a file that may be selectively viewable or non-viewable by a first user.

The payload objects display pane may have a selection: known recipient display pane, which may be selected to display which payload object(s) in the payload objects display pane have previously or are intended to be futurely provided to any one or group of known recipients.

The payload objects display pane may have a selection: Intended or Tentative goal with respect to a second party. Planned future transmissions may be driven by optimization to approach a goal. A pattern of past responses may be used to propose (or propose a change in) the goal.

According to an embodiment, in FIG. 1, the computer method 100 for sharing sensitive electronic information includes, in step 102, receiving, into a server computer, from a first party via a first graphical user interface (GUI) of a device having a first communication coordinate in network communication with the server computer, a selection of an agreement parameter corresponding to a proposed agreement required for transfer of designated payload data. Step 104 includes receiving, into the server computer, from the first party via the first GUI of the device having the first communication coordinate in network communication with the server computer, a designation of a second communication coordinate corresponding to a second party, the second party being the intended recipient of designated payload data. Step 106 includes establishing the designated payload data from the first party, the designated payload data being intended for delivery to the second party only after receiving of the proposed agreement by the second party and receiving an approval of the proposed agreement by the second party. Step 108 includes establishing, in the server computer, a first private encryption key assigned to the first party. Step 110 includes encrypting, with the server computer, the designated payload data using the first private encryption key and at least temporarily storing the encrypted payload data in a first protected memory. Step 112 includes generating, in the server computer, an electronic message for transmission to the second party, the electronic message including a first link and a request to activate the first link. Step 114 includes transmitting the electronic message to the second party at the second communication coordinate. Step 116 includes receiving actuation of the first link. Step 118 includes outputting the proposed agreement and an object (e.g., a clickwrap button) for receiving acknowledgement or approval by the second party for display to the second party via a GUI displayed on a second party electronic device. Step 120 includes receiving approval of the proposed agreement from the second party.

Optionally, the computer method 100 may include receiving a request to change the proposed agreement from the second party electronic device, transmitting the request to change the proposed agreement to the first party, and receiving an approval to change the proposed agreement or a revised proposed amendment from the first party.

According to an embodiment, the computer method 100 includes, in step 122, transmitting a second link to the second party, the second link corresponding to an expression of the designated payload data by the second party electronic device. Step 124 includes recording, with the server computer in a second protected memory accessible by at least the first party, the acceptance or approval of the agreement as a binding agreement. Step 126 includes recording, in the second protected memory, actuation of the second link and inferred expression of the designated payload data by the second party electronic device.

According to an embodiment, the first and the second communication coordinates each comprise an email address, an application user identity, a text (e.g., SMS) number, or a social network identity.

According to an embodiment, in step 102, receiving, into the server computer, the agreement parameter includes causing, with the server computer, a dashboard GUI to be displayed on an electronic display to the first party, and receiving graphical selections of one or more agreement types and/or one or more selections of selectable parameters for the proposed agreement. In one embodiment, in step 102, receiving, into the server computer, the agreement parameter includes receiving selection of a type of agreement. In another embodiment, in step 102, receiving, into the server computer, the agreement parameter includes receiving a remedy, a term, or a territory. Additionally and/or alternatively, in step 102, receiving, into the server computer, the agreement parameter includes receiving a custom agreement supplied by the first party. In one embodiment, in step 102, receiving, into the server computer, the agreement parameter includes receiving a selection of a social agreement in which the intended recipient personally promises to take action or not to take action upon receiving the designated payload data. Receiving a selection of a social agreement may include receiving an agreement wherein the intended recipient promises not to share the designated payload data with another party. In another embodiment, in step 102, receiving, into the server computer, the agreement parameter includes receiving a selection of a social agreement in which the intended recipient personally acknowledges receipt of the designated payload data.

According to an embodiment, in step 106, establishing the designated payload data from the first party includes receiving a first message from the first party into the server computer. The designated payload data may consist essentially of the first message. In another embodiment, in step 106, establishing the designated payload data from the first party includes receiving a designation of a predetermined payload data file from the first party. Additionally and/or alternatively, in step 106, establishing the designated payload data from the first party includes receiving a designation of a predetermined payload data stream from the first party.

According to an embodiment, in step 110, at least temporarily storing the encrypted payload data in the first protected memory includes writing the encrypted payload data to a blockchain data structure.

According to an embodiment, the computer method 100 further includes encrypting the proposed agreement using the first private encryption key or a second private encryption key assigned to the first party.

According to an embodiment, in step 122, transmitting the second link to the second party includes transmitting the second link corresponding to a public key for accessing the designated payload data. In another embodiment, in step 122, transmitting the second link to the second party includes transmitting the second link corresponding to a one-time use public key.

According to an embodiment, in step 110, the first protected memory comprises one or more secret memory locations, and further includes writing data corresponding to the one or more secret memory locations to a blockchain. In another embodiment, in step 110, the first protected memory comprises a distributed file system (DFS) having a very large address space. Such a DFS, for example IPFS, can keep data protected by algorithmically associating the designated payload data with a storage address. The algorithm, for example a hash and Merkle tree, will prevent the data from being read without proper presentation of a cryptographic key. The cryptographic key may itself be encrypted or otherwise encoded and written to the blockchain. A user presenting proper credentials to the blockchain may thus access the designated payload data via the blockchain.

According to an embodiment, in step 124, the second protected memory includes a blockchain.

According to an embodiment, the computer method 100 further includes recording access to the agreement by the second party onto a blockchain data structure (e.g., distributed across a plurality of nodes including nodes remote from the server computer).

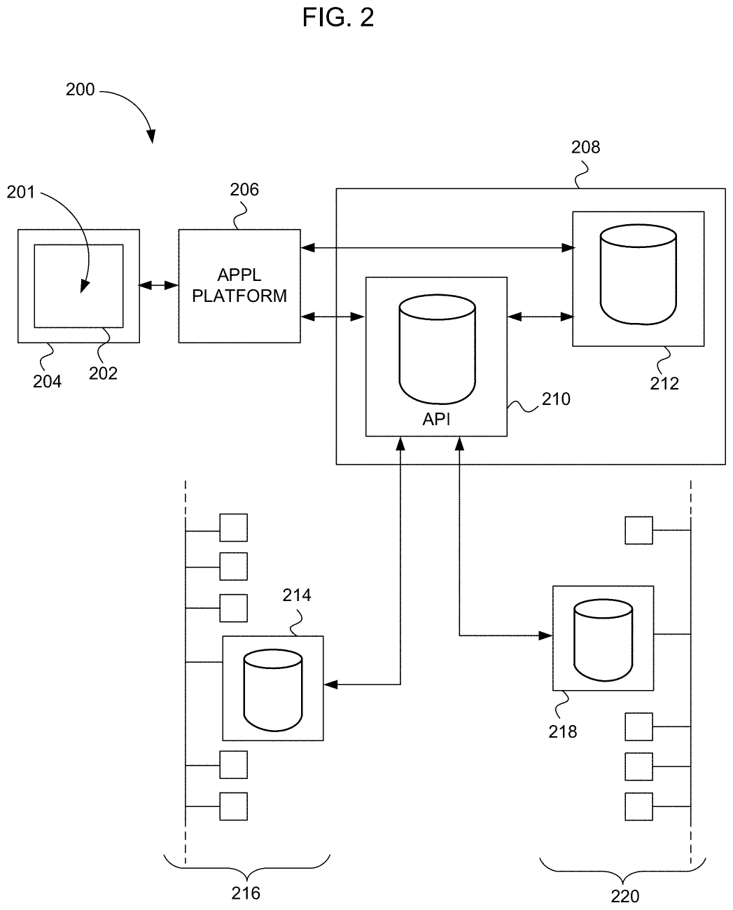

FIG. 2 is a system diagram showing principal portions of a system 200 for presenting immutable payload data to the user and for storing data, according to embodiments.

According to an embodiment, a computer system 200 for driving a graphical user interface (GUI) 201 to present payload data to a user includes an electronic display 202 of a user device 204 and a graphical user interface (GUI) 201. In an embodiment, the computer system 200 includes an application platform 206 configured to run a “front-end” application. The application platform 206 may be deployed on a server, for example for a web application (“web app”) environment. In another embodiment, the application platform 206 may include circuitry in the end user device 204, for example for a mobile application or desktop application environment. Alternatively, the application platform 206 may be split, with part of the front-end application being performed on a server computer and another part of the front-end application being performed on a user device 204.

In an embodiment, the computer system 200 includes a “back-end” server platform 208 that includes one or more server computers. In an embodiment, the back-end server platform 208 includes an application programming interface (API) server 210 that supports a rest API, and an authorization server 212 that provides authorization of users and provides storage for cryptographic keys. Connectivity between the application platform 206, the API server 210, and the authorization server 212 may be selected according to normal engineering preferences. For purposes of simplification and ease of description, description of back-end functions herein will generally refer to a server computer 208 that may include both an API server 210 and an authorization server 212, and optionally including additional servers such as a web server(s), load balancing server(s), RAID server(s), etc. Optionally, the server computer 208 may be deployed on a cloud service.

According to embodiments, the server computer 208 reads and commits blockchain transactions on a non-transitory computer-readable memory carrying at least one node 214 of a blockchain 216. According to embodiments, the server computer 208 performs read/write of data on a computer readable memory carrying at least one node 218 of a distributed file system (DFS) 220.

As described herein, a transaction on the blockchain 216 provides mediation for a corresponding metadata instance and/or payload data instance stored on the DFS 220. According to embodiments, the blockchain 216 may include a public blockchain. Public blockchains provide immutable storage of transactions, but may be too expensive to use for general purpose storage of data. Accordingly, the system 200 described herein may provide blockchain 216 mediation of data storage on the DFS 220 for immutable data payloads. Illustrative immutable data payloads may be valuable for providing security for permissioned data access between parties engaged in business development. For example, data payloads may include trade secrets, binding legal agreements, binding social agreements, investor slide decks, recipient responses to investor slide decks, access logs, and other documents for which proof of validity is important. In other embodiments, the inventors contemplate that payload data may include software carrying use contracts including open source software, accounting ledgers for attributing value disbursement, corporate “books”, copyrighted works of various types (encrypted or not encrypted), client lists, personal account storage and recovery, and others.

Among other advantages, this approach has been found to minimize blockchain transaction fees compared to storage of data directly on the blockchain 216 while providing virtually unlimited storage capacity.

As used herein, the term “blockchain mediation” and the like refers to a system wherein locations of metadata and of payload data in a DFS are tracked by carried data in blockchain transactions, the carried data corresponding to encrypted DFS storage locations. The carried data may be referred to as an operation (aka, “OP”) return value corresponding to a transaction. As used herein, DFS “address”, “storage location”, and the like may be referred to as a cryptographic hash of data saved at the storage location that operates as a link. This is referred to as a “hash (link)” herein. Optionally, the system described herein may also be used to link to encrypted or non-encrypted data at a uniform resource locator (URL) and/or Internet protocol (IP) address. Unless context indicates to the contrary, it will be understood that the term “hash (link)” may also refer to a link to a URL or IP address.

As used herein, the term “blockchain mediation” and the like refers to a system where locations of metadata and of payload data in a DFS are tracked by carried data in blockchain transactions, the carried data corresponding to encrypted DFS storage hash (links).

Referring to FIG. 2, according to an embodiment, a computer system 200 for immutable data storage and retrieval includes a back-end server 208 providing an API server 210 providing rest API and an authorization server 212. An application platform 206 (which may include an application server or a user device) is operatively coupled to the back-end server 208 and operatively coupled an electronic display 202 on a user device 204 for displaying a graphical user interface (GUI) 201 driven by a computer application running on the application platform 206. In an embodiment, the application is a web application that runs on a server and cooperates with a web browser running on the user device. In other embodiments, the application is a local application that runs on the user device. The application cooperates with the back-end server 208 to provide immutable blockchain mediated data storage and retrieval. The back-end server 208 is operatively coupled to a node 218 of a distributed file system (DFS) 220 for holding (at least some) payload data and metadata which tracks the payload data. The back-end server 208 is also operatively coupled to a node 214 of a blockchain 216 that carries access data in blockchain transactions. The carried data includes hash (link) data that identifies storage locations in the DFS 220. Electronic wallets carry metadata instances that provide links to blockchain transactions which carry hash (link)s.

In an embodiment, a user may access payload data by selecting a project icon on the GUI 201, the project icon representing an electronic wallet; and selecting a payload icon on the GUI 201, the payload icon representing a payload instance associated with the project. The back-end server 208 responsively reads a current metadata at a metadata address to obtain a blockchain transaction ID, reads the blockchain transaction ID from the blockchain node 214 to obtain carried data, decrypts the carried data with a blockchain decryption key to obtain a hash (link) associated with the selected payload icon, reads the DFS hash (link) from the DFS node 218 to obtain encrypted payload data, decrypts the encrypted payload data with a storage decryption key to obtain payload data, and presents the payload data to the user via the user device 204. The back-end server 208 may further log the user access of the payload data in the current metadata, encrypt a copy of the current metadata with a storage encryption key, save the encrypted metadata at a new hash (link) in the DFS 220 at the DFS node 218, encrypt the new hash (link) with a blockchain encryption key, write a transaction to the blockchain 216 at the blockchain node 214 with the encrypted new hash (link) as carried data, determine a transaction ID for the transaction, and write the transaction ID to the current metadata.

In an embodiment, the DFS node includes an Interplanetary File System (IPFS) node. In an embodiment, the node of the DFS 204 includes a FileCoin node.

In an embodiment, the second payload data includes an agreement for sharing the first payload data 104 between a first party and a counterparty.

According to an embodiment, the first payload data includes a trade secret, and the second payload data includes a secrecy agreement.

According to an embodiment, a decryption key holder accesses information at a current metadata storage location. The current metadata storage location may address an authorized metadata storage location, and at least one of the current metadata storage location or the authorized metadata storage location may include metadata corresponding to at least one of a white list or a black list holding at least one of accessing parties or a decryption key.

In an embodiment, the metadata may include an instance of JavaScript Object Notation (JSON). The JSON instance may include a specification of a previous linked JSON instance. In another embodiment, the JSON instance includes a specification of a first and a second corresponding payload data instances having a relationship therebetween. Additionally and/or alternatively, the JSON instance includes a specification of a relationship between a first and a second corresponding payload. In an embodiment, the system 200 provides encrypted, immutable (payload) data storage to authorized users. The data storage may be permanent. Optionally, obsolete data may be periodically swept to free storage.

Referring again to FIG. 2, the computer system 200 may provide two main components, a front end 206 and a back end 208, that cooperate to provide encrypted payload data storage and retrieval on a distributed file system (DFS) 220 via access control stored on a public blockchain 216. The system 200 may use the Bitcoin Cash (BCH) blockchain for access control and for optional fee payment for use of the DFS 220.

The front end 206 may provide application support specific to a particular use case. The front end 206 may include an application operatively coupled to a physical electronic display 202. The application 206 and display 202 may be configured to provide a graphical user interface (GUI) 201 to a user. The application may include an HTML (/XML) web application that uses a cascading style sheet (CSS) standard.

The back end 208 may provide encrypted payload data storage and retrieval on the DFS 220 via access control stored on a public blockchain 216 responsive to communications with front end 206 instances.

The back end 208 may include an API server 210 that communicates with the front end 206 via a rest API that interfaces to the blockchain 216, the DFS 220, and an authorization server 212. The back end 208 also may include the authorization server 212 that manages user authorization and authentication and manages cryptographic key access.

A user may establish and obtain access to an account via a JWT (“jot token”) communication session between the front end 206 and the back end 208. The authorization server 212 may authorize a user session, informing both the front end 206 and the API server 210 via encrypted communications.

The application 206 may transmit (a) request(s) to the API server 210 for metadata parameters.

The API server 210 may request corresponding metadata encryption keys from the authorization server 212, receive respective metadata encryption keys for authorized projects, query an encrypted internal database for “projects” for which the user is authorized, and output display parameters for icons corresponding to the authorized projects to the application 206. The application 206 may display icons corresponding to the projects on the electronic display 202 via the GUI 201.

The “projects” may be embodied as electronic wallet addresses configured to provide and receive data respectively for transmission to and reception from other wallet addresses as blockchain transactions. In this way, the system 200 may operate as a service for transmitting and receiving (optionally encrypted) information between users while providing an immutable record of each transmission and/or reception transaction.

In an embodiment, when the user selects a project icon and payload icon via the GUI 201, the API server 210 receives the selection as a payload data identifier, reads metadata corresponding to the project to obtain a payload data storage hash (link), reads the encrypted payload data from the payload hash (link), requests a storage decryption key from the authorization server 212 corresponding to the project, decrypts the payload data, parses and encrypts the payload data per the current JWT token, transmits the payload data to the application 206, and logs the access onto the current metadata object. The application 206 may decrypt the selected payload data with the JWT session key, and drive the GUI to display the payload data to the user on the electronic display 202.

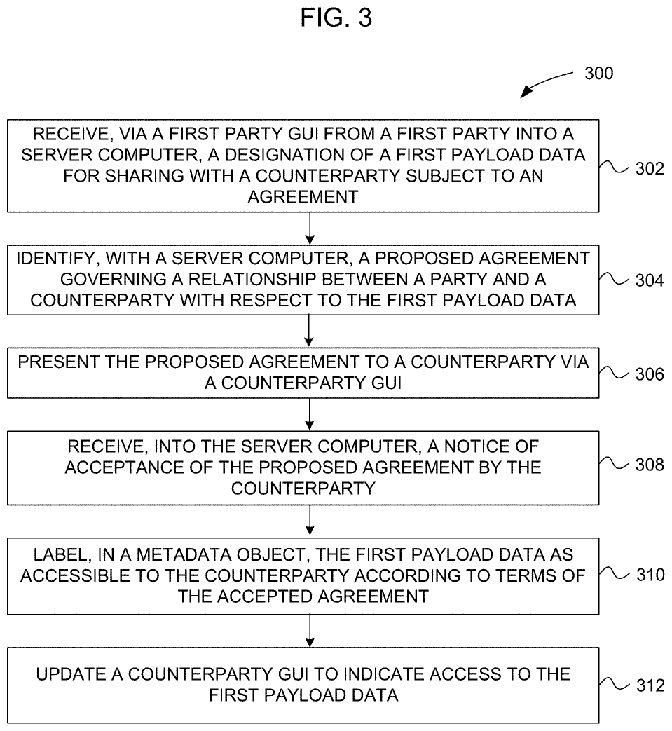

FIG. 3 is a flowchart illustrating a computer method 300 for blockchain mediation of an agreement between a party and a counterparty, according to an embodiment.

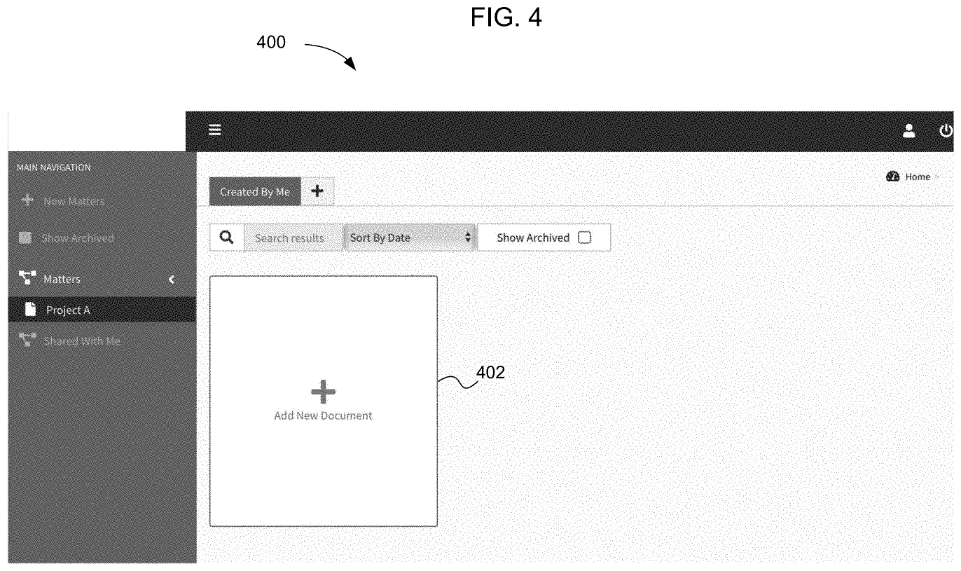

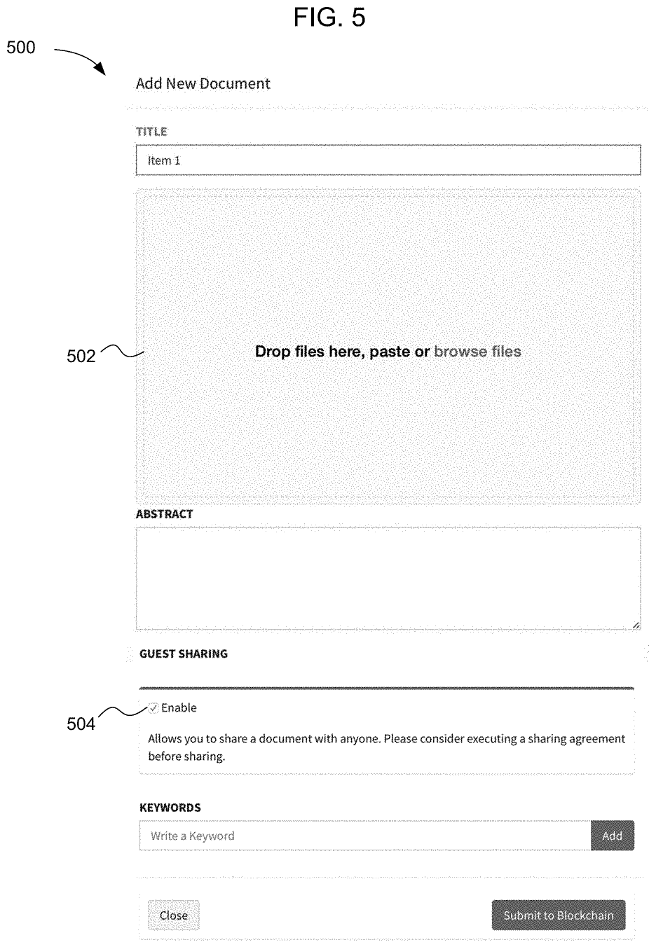

FIG. 4 is a depiction of a graphical user interface 400 for receiving a command, into a server computer 208, for establishing a new payload data file, according to an embodiment. The first user may click on the icon 402 indicating a command to “Add new document”. The server computer 208 may respond by causing an add-new-document window to be displayed by the graphical user interface 500 shown in FIG. 5.

FIG. 5 is a depiction of a graphical user interface 500 for adding a new document as a payload data object, according to an embodiment. Upon actuation of the “add new document” control 402, the server computer 208 may cause display of the add-new-document window 500. The first party may control loading of data files into blockchain-mediated memory, and insertion and/or selection of source metadata that is subsequently written to a current JSON metadata file in association with the loaded data files, by indicating a file to a paste/browse object 502. A transferrable sharing agreement status may be enabled by controlling the graphical guest sharing object 504.

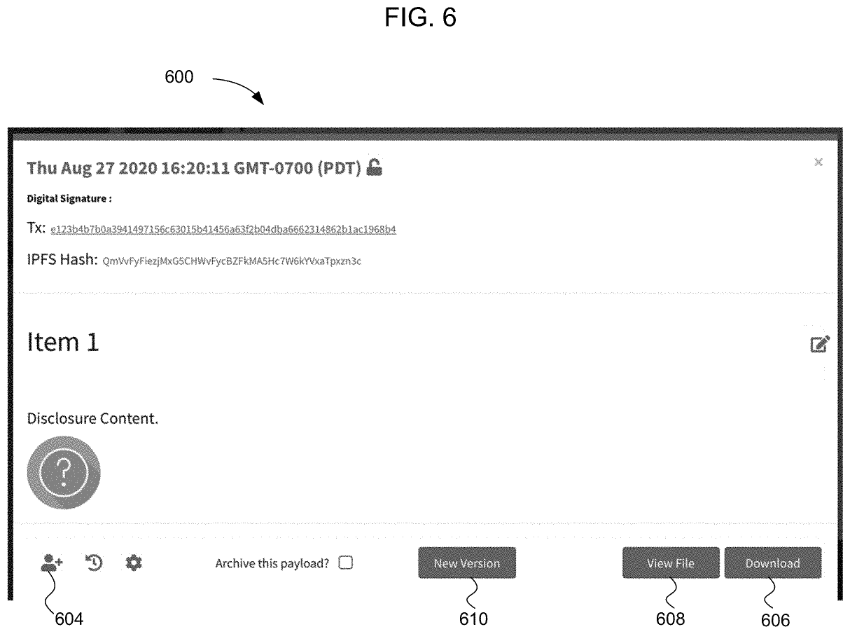

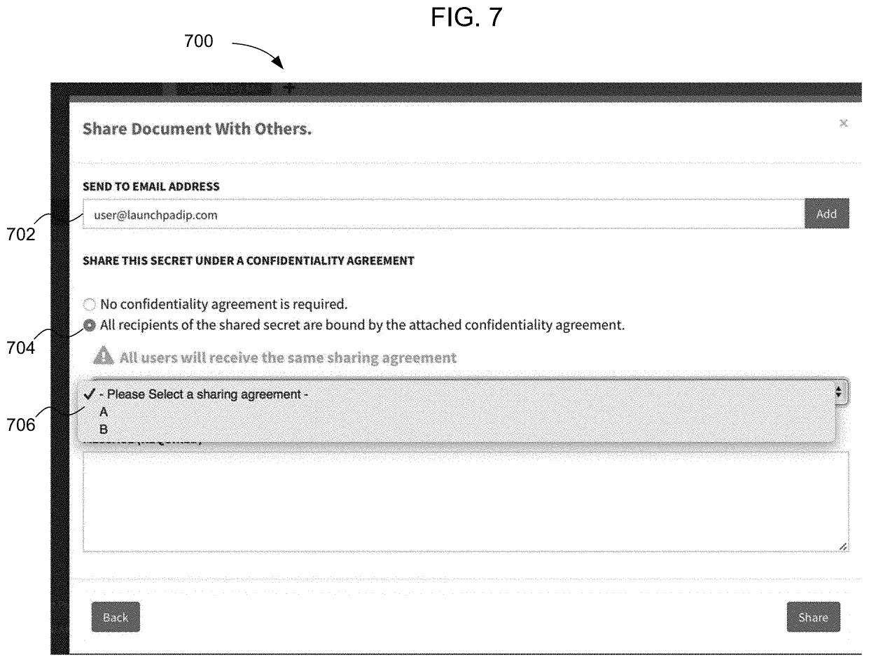

FIG. 6 is a depiction of a graphical user interface 600 for receiving a designation that the first payload data file is intended to be shared with a counterparty, according to an embodiment. The payload is identified in an identification region 602 according to a blockchain transaction ID (“TX”) carrying metadata related to the corresponding encrypted payload data stored at an IPFS hash link. This designation provides a path to immutable evidence of the existence of and timestamp of creation of the storage instance of a data file having a substantially unique hash. A sharing icon 604 may be actuated by the first party via the graphical user interface 600. According to an embodiment, actuation of the sharing icon 604 causes display of a sharing control window 700 shown in FIG. 7.

FIG. 7 is a depiction of a graphical user interface 700 for selecting a sharing agreement to govern terms under which the payload data is shared with the counterparty, according to an embodiment. In an embodiment, the first party may control designation of one or more counterparties by entering communication coordinates such as email addresses into the “send to” field 702. The first party may enter commands regarding transferability of a sharing agreement via a radio button 704. Designation of a sharing agreement may be actuated by selecting an agreement from a list in a drop-down menu 706.

According to an embodiment, referring to FIG. 3, a computer method 300 for blockchain mediation of an agreement between a party and a counterparty includes, in step 302, receiving, via a first party graphical user interface from a first party into a server computer, a designation of a first payload data file for sharing with a counterparty subject to an agreement. Step 304 includes identifying, with a server computer, a proposed agreement governing a relationship between a party and a counterparty with respect to the first payload data. Step 306 includes presenting the proposed agreement to a counterparty via a counterparty graphical user interface. Step 308 includes receiving, into the server computer, a notice of acceptance of the proposed agreement by the counterparty. Step 310 includes labeling, in a metadata object, the first payload data as accessible to the counterparty according to terms of the accepted agreement. Step 312 includes updating the counterparty graphical user interface to indicate access to the first payload data.

According to an embodiment, receiving, via a graphical user interface from a first party into a server computer, a designation of a first payload data for sharing with the counterparty subject to the agreement (in step 302) includes receiving actuation of a share icon 604 (see FIG. 6) in a payload data window 602.

According to an embodiment, receiving, via a graphical user interface from a first party into a server computer, a designation of a first payload data for sharing with the counterparty subject to the agreement (in step 302) includes receiving a selection of a sharing agreement 704 option (see FIG. 7) by the first party, and receiving selection of one of a plurality of available sharing agreements 706 by the first party.

According to an embodiment, receiving, via a graphical user interface from a first party into a server computer, a designation of a first payload data for sharing with the counterparty subject to the agreement (in step 302) includes receiving an input from the first party indicating that any counterparty may view the first payload data subject to the agreement. For example, the first party may enter a wildcard character into a recipient field 706 (see FIG. 7), indicating that any party may view the first payload data, subject to the agreement.

According to an embodiment, receiving, via a graphical user interface from a first party into a server computer, a designation of a first payload data for sharing with the counterparty subject to the agreement (in step 302) includes receiving actuation of a share icon 604 (see FIG. 6) in a payload data window 602.

According to an embodiment, identifying, with a server computer, the proposed agreement governing a relationship between a party and a counterparty with respect to the first payload data (in step 304) includes receiving no agreement designation by the first party, and using a default agreement as the proposed agreement.

According to an embodiment, the computer method 300 further includes receiving, into the server computer via the first party GUI, designation of a second payload data. The second payload data may include a proposed sharing agreement.

According to an embodiment, the computer method 300 further includes receiving, into the server computer via the first party GUI, selection of a proposed sharing agreement from a plurality of predefined sharing agreements.

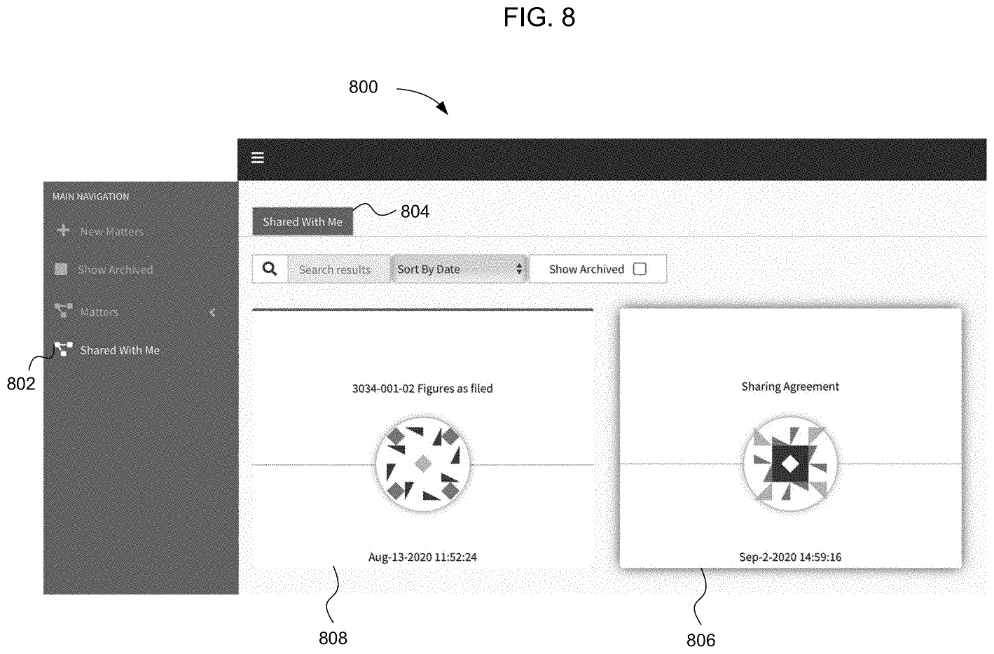

FIG. 8 is a depiction of a graphical user interface 800 for presenting a proposed agreement to the counterparty, according to an embodiment.

According to an embodiment, referring to FIGS. 3 and 8, presenting the proposed agreement to the counterparty via the graphical user interface (in step 306) includes presenting an agreement for acceptance by the counterparty. In an embodiment, the counterparty may click a “shared with me” icon 802 to cause a “shared with me” window 804 to be displayed. In an embodiment, a user may further select a subset of all payload data objects that may have been shared with the user aside from the user's instant counterparty role. In an embodiment the sharing agreement 806 is presented as an object in the “shared with me” window 804. The counterparty may click on the sharing agreement to bring up a window or modal similar to the graphical user interface 600 shown in FIG. 6. The counterparty may subsequently issue a command to view and/or download the sharing agreement for review and execution, such as by clicking the “download” or “view file” control 606, 608. To negotiate a sharing agreement or to upload an executed copy of the sharing agreement, the counterparty may click the “new version” control 610 to upload a new payload including a signature and/or modifications that is linked, via a metadata file, to the previous version. Upon uploading the new version, the system may alert the first party that a modified payload data object is waiting for review or counter-execution. The alert may be made in the application or may be made via an automatically generated email message or other communication modality message. To view a history of changes in a sharing agreement, referring to FIG. 4, the first party or counterparty may click a “show archived” control 404 to display representations of previous sharing agreement objects. According to an embodiment, an old version of a payload data object that was previously accessible to a particular user, including an old version of a sharing agreement replaced by a “new version” 610 control are not deleted. Rather, replaced versions may archived for future review.

Referring again to FIG. 8, other payload objects previously shared with the counterparty by the first party, such as a payload object 808 may also be displayed in the “shared with me” pane 804. In an embodiment, the payload object 808 represents payload data previously shared with the counterparty under a default sharing agreement.

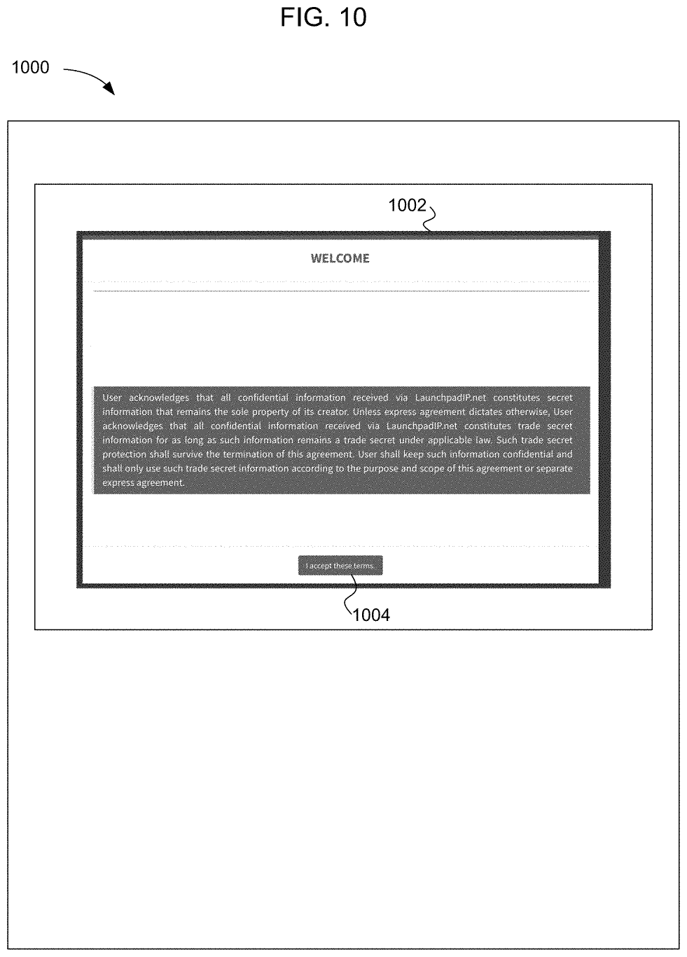

FIG. 10 is a depiction of a display 1000 of a default sharing agreement 1002 comprising a standard user agreement for acceptance by any user, including the counterparty, using an acknowledgement control 1004, according to an embodiment. The default sharing agreement may optionally be a socially-enforceable sharing agreement.

Referring again to FIGS. 3 AND 8, the computer method 300 further includes, after presenting the proposed agreement to the counterparty (in step 306), receiving one or more proposed modifications to the sharing agreement via the counterparty GUI, and transmitting the proposed changes to the first party. According to embodiments, the sharing agreement may be negotiated and iterated between the first party and the counterparty according to payload data transmission steps indicated above, wherein the sharing agreement is a particular form of payload data.

In an embodiment, receiving, into the server computer, a notice of acceptance of the proposed agreement by the counterparty (in step 308) includes receiving an executed agreement as payload data.

In an embodiment, receiving, into the server computer, a notice of acceptance of the proposed agreement by the counterparty (in step 308) includes receiving a message that the counterparty has accepted the proposed agreement.

In an embodiment, receiving, into the server computer, a notice of acceptance of the proposed agreement by the counterparty (in step 308) includes receiving a message that the counterparty has accepted a predefined agreement. For example, a successful login of the counterparty may include evidence that the counterparty accepted a default sharing agreement (an example of which is shown in FIG. 10).

In an embodiment, receiving, into the server computer, a notice of acceptance of the proposed agreement by the counterparty (in step 308) includes receiving a counter-execution by the first party.

According to an embodiment, the computer method 300 further includes writing evidence data corresponding to execution of the agreement with blockchain mediation. In an embodiment, writing evidence data corresponding to execution of the agreement with blockchain mediation includes adding execution evidence data to the metadata object. In an embodiment, writing evidence data corresponding to execution of the agreement with blockchain mediation includes recording the executed agreement as payload data. In an embodiment, writing evidence data corresponding to execution of the agreement with blockchain mediation includes adding an evidence data access link to the metadata object, hashing the metadata object, storing encrypted metadata object at a hash link, and recording an encrypted hash link to the encrypted metadata object as carried data in a blockchain transaction. The blockchain transaction may include an immutable timestamp.

In an embodiment, the executed agreement specifies access credentials corresponding to the counterparty. The executed agreement may specify an access condition for the counterparty. In an embodiment, the access condition includes permanent access. In another embodiment, the access condition may include temporary access. The access condition may include a limited number of accesses. In an embodiment, the executed agreement specifies an access modality. The access modality may consist of viewing the payload data in the counterparty GUI. The access modality may include a right to download a file corresponding to the payload data.

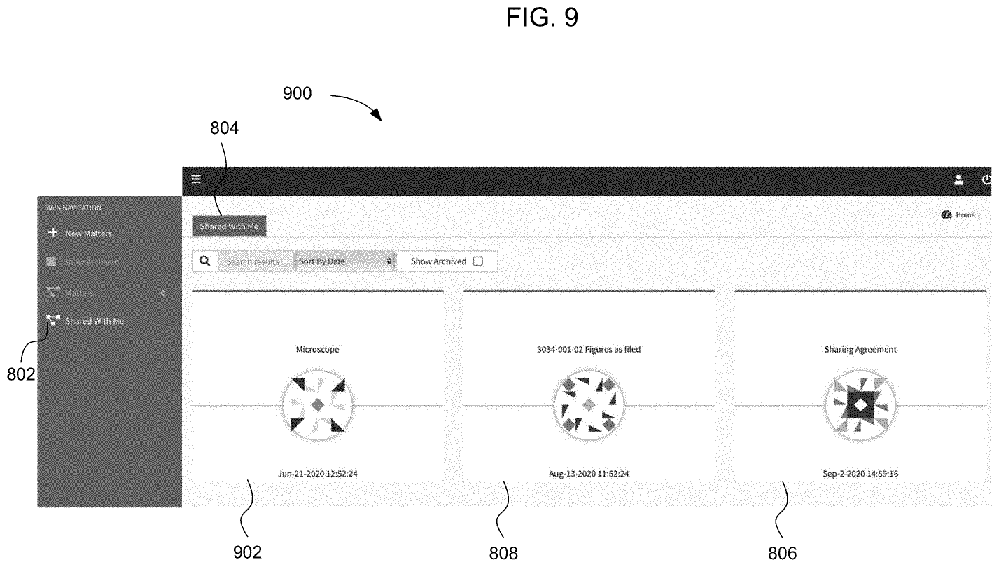

FIG. 9 is a depiction of a graphical user interface 900 for indicating access to shared first payload data 902, according to an embodiment. According to an embodiment, the computer method 300 further includes receiving an input from the counterparty via the counterparty GUI 900 to access the first payload data, such as by clicking the first payload data control 902. Clicking the control 902, indicating a desire by the counterparty to view the first payload data, may cause the server computer to display a first payload data window, such as the graphical user display 600, shown in FIG. 6. Receiving actuation of the download or view file controls 606, 608 by the counterparty may cause the server computer to retrieve encrypted first payload data from encrypted storage (see 218, FIG. 2) using the first payload data hash link (listed in the corresponding metadata), decrypt the first payload data (using a decryption key from the authorization server (see 212, FIG. 2), and display the first payload data to the counterparty via the counterparty electronic display 202 and optionally GUI 201.

According to an embodiment, the computer method 300 further includes receiving an input from the counterparty into the server computer via the counterparty GUI to view the first payload data, retrieving encrypted first payload data from encrypted storage using a hash link with the server computer, decrypting the first payload data with the server computer, and downloading the first payload data to the counterparty from the server computer to a counterparty device 204.

According to an embodiment, the counterparty may further share the payload data with others under the terms of the sharing agreement, according to permission granted in the guest sharing control (e.g., see the guest sharing control 504, FIG. 5). Additionally or alternatively, the counterparty may download the first payload data, modify the first payload data to make second payload data, and share the second payload data back to the first party, for example under an agreement to provide digital art, design, copywriting, and/or review services. Such an act of making a derivation and sharing the derivation exclusively back to the first party may be generally not considered a breach of the sharing agreement.

According to an embodiment, the computer method 300 further includes receiving data, into the server computer, of at least one suspected breach of the sharing agreement, and taking action with respect to the suspected breach. In an embodiment, taking action with respect to the suspected breach includes notifying the first party of the suspected breach via the first party GUI.

In an embodiment, if the system receives data consistent with a breach, by a counterparty, of a sharing agreement, the system may flag the counterparty, the counterparty's account, and/or all accounts associated with the counterparty as a suspected or, upon receiving dispositive data or additional data consistent with breaches, a proven or recurrent violator of sharing agreements. In an embodiment, a status of a counterparty as a suspected, proven, or recurrent violator of sharing agreements may be flagged to potential future first parties. In an embodiment, a recurrent or proven violator of sharing agreements may result in blacklisting of the counterparty by the application. Blacklisting may include revocation of use of the platform by the guilty party. In an embodiment, taking action with respect to the suspected breach includes banning the counterparty.

In an embodiment, the server computer may perform image processing and/or text processing on received new payload data from a user. The image processed or text processed new payload data may be compared to previously received payload data, where the previously shared payload data is subject to a sharing agreement. When the server computer determines that a newly received designated payload data is similar to previously received payload data received under an agreement, the server computer may flag the instance as a suspected violation of the sharing agreement. Additionally or alternatively, the server computer may flag the instance as a suspected violation of the sharing agreement when the counterparty attempts to share the newly received payload data to any party other than the first party. Such flagging may be limited to cases where the sharing agreement is not a negation of the default sharing agreement (e.g., see 1002, FIG. 10).

In another embodiment, the server computer may cause an Internet indexing engine to crawl the Internet, looking for evidence of a shared payload data or a derivation thereof “in the wild”. Obtaining evidence of decrypted previously shared payload data in the wild may be flagged as evidence of a suspected violation of a sharing agreement by one or more counterparties that previously received the previously shared payload data. In an embodiment, receiving data, into the server computer, of at least a suspected breach of the sharing agreement includes causing an Internet indexing engine to crawl the Internet and look for instances in the wild of improperly shared content corresponding to the first payload data.

In an embodiment, the server computer may apply or insert a unique electronic watermark to shared decrypted payload data, prior to making the shared payload data available to a counterparty in a GUI (e.g., see 900, 902, FIG. 9) to aid in tracking instances of sharing agreement violations.

According to an embodiment, the computer method 300 further includes performing processing on a received payload data to obtain identifying features of the payload data, and using the identifying features to search for instances of a breach of the sharing agreement. In an embodiment, performing processing on a received payload data to obtain identifying features of the payload data includes performing image processing. In an embodiment, performing processing on a received payload data to obtain identifying features of the payload data includes performing text processing. Performing processing on a received payload data to obtain identifying features of the payload data may include performing audio processing. Performing processing on a received payload data to obtain identifying features of the payload data may include performing video processing.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1-20. (canceled)

21. A computer method for blockchain mediation of an agreement between a party and a counterparty, comprising:
receiving, via a first party graphical user interface from a first party into a server computer, a designation of a first payload data file for sharing with a counterparty subject to an agreement;
identifying, with a server computer, a proposed agreement governing a relationship between a party and a counterparty with respect to the first payload data;
presenting the proposed agreement to the counterparty via a counterparty graphical user interface;
receiving, into the server computer, a notice of acceptance of the proposed agreement by the counterparty;
labeling, in a metadata object, the first payload data as accessible to the counterparty according to terms of the accepted agreement; and
updating the counterparty graphical user interface to indicate access to the first payload data.

22. The computer method of claim 21, wherein receiving, via the graphical user interface from the first party into the server computer, the designation of the first payload data for sharing with the counterparty subject to the agreement includes:
receiving actuation of a share icon in a payload data window.

23. The computer method of claim 21, wherein receiving, via the graphical user interface from the first party into the server computer, the designation of the first payload data for sharing with the counterparty subject to the agreement includes:
receiving a selection of a sharing agreement option by the first party; and
receiving selection of one of a plurality of available sharing agreements by the first party.

24. The computer method of claim 21, wherein receiving, via the graphical user interface from the first party into the server computer, the designation of the first payload data for sharing with the counterparty subject to the agreement includes:
receiving an input from the first party indicating that any counterparty may view the first payload data subject to the agreement.

25. (canceled)

26. The computer method of claim 21, wherein identifying, with the server computer, the proposed agreement governing the relationship between the party and the counterparty with respect to the first payload data includes:
receiving no express agreement designation by the first party; and
using a default agreement as the proposed agreement.

27. The computer method of claim 26, wherein presenting the proposed agreement to the counterparty via the graphical user interface includes presenting a standard user agreement for acceptance by the counterparty.

28-29. (canceled)

30. The computer method of claim 21, further comprising, after presenting the proposed agreement to the counterparty, receiving one or more proposed modifications to the sharing agreement via the counterparty GUI; and
transmitting the proposed changes to the first party.

31. The computer method of claim 21, wherein receiving, into the server computer, a notice of acceptance of the proposed agreement by the counterparty includes:
receiving an executed agreement as payload data.

32. The computer method of claim 21, wherein receiving, into the server computer, the notice of acceptance of the proposed agreement by the counterparty includes:
receiving a message that the counterparty has accepted the proposed agreement.

33. (canceled)

34. The computer method of claim 21, further comprising:
receiving a counter-execution by the first party.

35. (canceled)

36. The computer method of claim 21, further comprising adding execution evidence data to the metadata object.

37. The computer method of claim 21, further comprising:
recording the accepted agreement as payload data.

38. The computer method of claim 37, wherein recording the accepted agreement as payload data includes:
adding an evidence data access link to the metadata object;
hashing the metadata object;
storing encrypted metadata object at a hash link; and
recording the hash link to the encrypted metadata object as carried data in a blockchain transaction, the blockchain transaction including an immutable timestamp.

39. The computer method of claim 21, wherein the executed agreement specifies access credentials corresponding to the counterparty.

40. The computer method of claim 21, wherein the executed agreement specifies an access condition for the counterparty.

41. The computer method of claim 40, wherein the access condition includes permanent access.

42. The computer method of claim 40, wherein the access condition includes temporary access.

43. The computer method of claim 40, wherein the access condition includes a limited number of accesses.

44. The computer method of claim 21, wherein the executed agreement specifies an access modality.

45. The computer method of claim 44, wherein the access modality consists of viewing the payload data in the counterparty GUI.

46. The computer method of claim 44, wherein the access modality includes a right to download a file corresponding to the payload data.

47. The computer method of claim 21, further comprising:
receiving an input from the counterparty via the counterparty GUI to view the first payload data;
retrieving encrypted first payload data from encrypted storage using a hash link;
decrypting the first payload data; and
displaying the first payload data to the counterparty via the counterparty GUI.

48. The computer method of claim 21, further comprising:
receiving an input from the counterparty via the counterparty GUI to view the first payload data;
retrieving encrypted first payload data from encrypted storage using a hash link;
decrypting the first payload data; and
downloading the first payload data to the counterparty.

49-59. (canceled)

60. The computer method of claim 21, further comprising:
prior to making the first payload data available to the counterparty, performing processing, by the server computer, to insert a unique electronic watermark into the decrypted first payload data.
